(19) United States
(12) Patent Application Publication
(10) Pub. No.: US 2004/0263064 A1
(43) Pub. Date: Dec. 30, 2004

(54) Integrated double-sided organic light-emitting display

(76) Inventor: Cheng-Wen Huang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/601,714

(22) Filed: Jun. 24, 2003

(51) Int. Cl. H05B 33/00

(52) U.S. Cl. 313/504; 313/506

(57) ABSTRACT

An integrated double-sided organic light-emitting display includes a substrate on which a main-panel, a sub-panel, and a control module are installed. The main-panel is used for generating a main-image light, which progresses along a first display direction. The sub-panel is used for generating a sub-image light, which progresses along a second display direction, and the first display direction and the second display direction are mutually reversed directions in free space. The control module is electrically connected to the main-panel and the sub-panel for controlling operations of the main-panel and the sub-panel.

### BACKGROUND OF INVENTION

1. Field of the Invention

The present invention relates to an integrated double-sided organic light-emitting display, and more specifically, to an integrated double-sided organic light-emitting display including a substrate on which a main-panel, a sub-panel, and a control module for controlling operation of the integrated double-sided organic light-emitting display are installed.

2. Description of the Prior Art

Owing to the rapid development of wireless communication systems, people can access resources, exchange information, and share experiences via a mobile phone or other wireless communication devices anytime and anywhere. Nowadays, the mobile phone has double-sided displays, a main-panel and a sub-panel, where the sub-panel is used for displaying simple text or images, and the main-panel is used for displaying exquisite images and text, even images taken by a build-in camera of the mobile phone.

The double-sided display is constituted by using liquid crystal display panels (LCD panels). Please refer to FIG. 1 illustrating a schematic diagram of a conventional double-sided light-emitting LCD panel 10. The double-sided light-emitting LCD panel 10 comprises a main-panel 12 having a corresponding main LCD panel 16 and a main back light unit (BLU) 14, and a sub-panel 22 having a corresponding sub LCD panel 20 and a sub back light unit (BLU) 18. The main LCD panel 16 and the main back light unit 14 are assembled together with a bezel, and so are the sub LCD panel 20 and the sub back light unit 18. As shown in FIG. 1, progressing direction of main-image light emitted by the main back light unit 14 of the main-panel 12 is mutually reversed with that of sub-image light emitted by the sub back light unit 18 of the sub-panel 22 in free space.

Furthermore, a main-control module 24 and a sub-control module 26 are required for controlling operations of the main-panel 12 and the sub-panel 22 respectively. In addition, due to the mutually reversed directions between the main-image light emitted by the main-panel 12 with the main back light unit 14 and the sub-image light emitted by the sub-panel 22 with the sub back light unit 18, integrating the main back light unit 14 and the sub back light unit 18 in one is complicated. Therefore, the double-sided light-emitting LCD panel 10, because of a requirement of both the main back light unit 14 and the sub back light unit 18, has larger thickness. Moreover, the main control module 24 for the main-panel 12 and the sub control module 26 for the sub-panel 22 are reformable to reduce extra cost.

To solve the above problem, an Organic Light Emitting Diode (OLED) display panel, due to its feature of high brightness, light weight, small volume, full color and few visual angle, is suitable. More important is that the OLED is unlike the LCD panel requiring the back light module, not only saving power, but also reducing the thickness of the display panel. Consequently, latest portable electronics devices, such as mobile phones, PDAs, and so on, have already used such OLEDs to overcome disadvantages of the conventional LCD display panel.

### SUMMARY OF INVENTION

It is therefore a primary objective of the claimed invention to provide an integrated double-sided organic light-emitting display for generating at least two reversed directions image light in free space to solve the above problem.

Briefly summarized, the claimed invention provides an integrated double-sided organic light-emitting display panel comprising a substrate, a main-panel installed on the substrate for generating a main image light substantially progressing along a first displaying direction, a sub-panel installed on the substrate for generating a sub image light substantially progressing along a second displaying direction, and a control module electrically connected with the main-panel and the sub-panel for controlling operations of the main-panel and the sub-panel. The first displaying direction is mutually reversed to the second displaying direction in free space.

The claimed invention also provides an integrated double-sided organic light-emitting display panel comprising a substrate and a plurality of displaying modules installed on the substrate for generating a corresponding plurality of image light. Each displaying module comprises a top electrode, a bottom electrode, and an organic light emitting layer installed between the top electrode and the bottom electrode for generating a corresponding image light. The integrated double-sided organic light-emitting display panel also contains a control module for controlling operations of the plurality of displaying module.

It is an advantage of the present invention that the integrated double-sided organic light-emitting display comprises a main-panel and a sub-panel both installed on an identical substrate and controlled by an identical control module. The main-panel and a sub-panel is used to generate two mutually reversed image lights, greatly reducing a thickness of a normal LCD display panel.

It is a further advantage of the present invention that the integrated double-sided organic light-emitting display comprises a plurality of displaying modules installed on an identical substrate and controlled by an identical control module, to generate a plurality of image light progressing along different directions, greatly reducing a thickness of a normal LCD display panel.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a schematic diagram of a conventional double-sided light-emitting LCD panel.

FIG. 2 is a first embodiment of an integrated double-sided organic light-emitting display according to the present invention.

FIG. 3 is a schematic diagram of the first embodiment on the side of the main-panel.

FIG. 4 is a schematic diagram of the first embodiment on the side of the sub-panel.

FIG. 5 is a schematic diagram of a second embodiment of an integrated double-sided organic light-emitting display according to the present invention.

### DETAILED DESCRIPTION

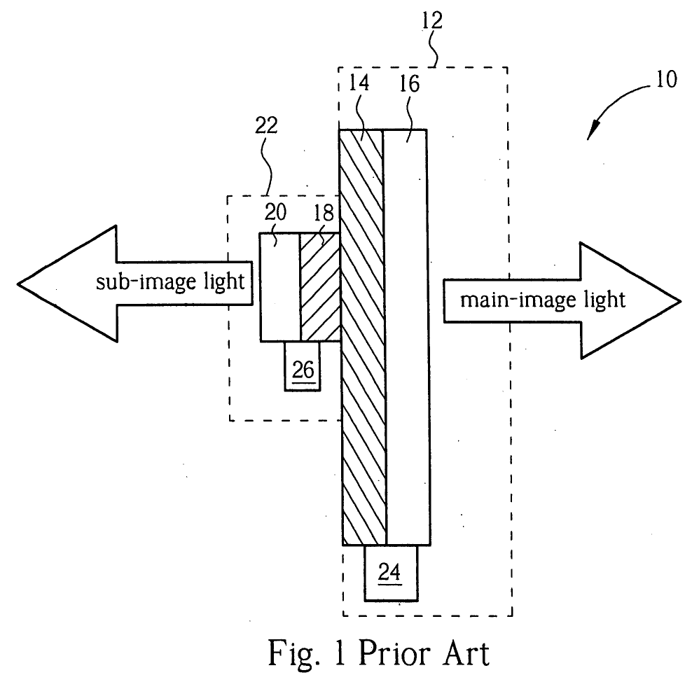

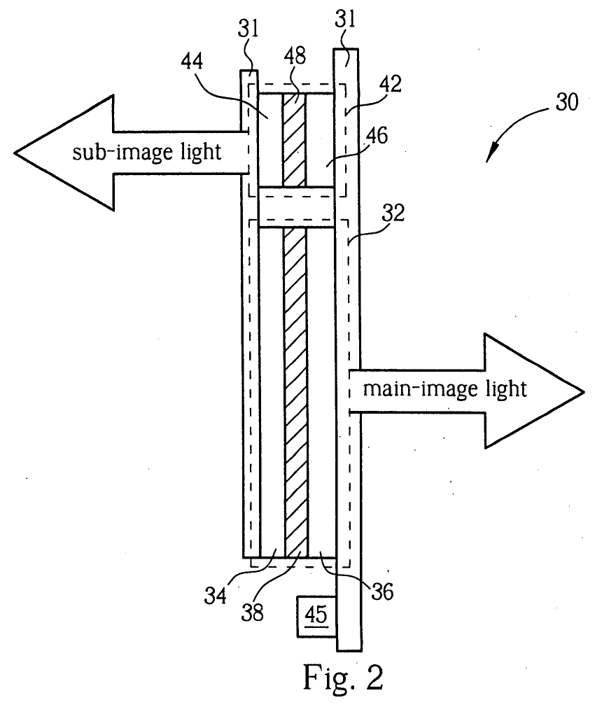

Please refer to FIG. 2, which shows a first embodiment of an integrated double-sided organic light-emitting display 30 according to the present invention. The integrated double-sided organic light-emitting display 30 comprises a substrate 31(there are two pieces of substrates 31 shown in FIG. 2) on which a main-panel 32, a sub-panel 42 and a control module 45 are installed. The substrate 31 can be a glass substrate or a plastic substrate. The main-panel 32 generates a main-image light substantially progressing along a first display direction (shown in FIG. 2). The sub-panel 42 is installed on the same side as the main-panel 31 on the substrate 31, such that a thickness of the whole integrated double-sided organic light-emitting display 30 can be limited and is much smaller than that of the conventional double-sided light-emitting LCD panel 10 illustrated in FIG. 1. The sub-panel 42 is used for generating a sub-image light substantially progressing along a second display direction against the first display direction. In other words, the integrated double-sided organic light-emitting display 30 utilizes the main-panel 32 and the sub-panel 42 for respectively generating reversed image light directions. In addition, the control module 45 electrically connected with both the main-panel and the sub-panel 42 is used for controlling operations of the main-panel 32 and the sub-panel 42.

The integrated double-sided organic light-emitting display 30 can be an Organic Light Emitting Diode (OLED) display panel or a PLED display panel of which the main-panel 32 and the sub-panel 42 are made. Please keep referring to FIG. 2. The present invention main-panel 32 comprises an upper main-substrate 34, a bottom main-substrate 36, and a main organic light emitting layer 38 therebetween. Similarly, the sub-panel 42 comprises an upper sub-substrate 44, a bottom sub-substrate 46 and a sub organic light emitting layer 48 therebetween. The upper main substrate 34, the bottom main substrate 36, the upper sub-substrate 44, and the bottom sub-substrate 46 are electrodes with metal material. Differing from the conventional LCD display panel in need of back light unit (the main back light unit 14 and the sub back light unit 18 depicted in FIG. 1), the organic light emitting layer, due to utilizing an organic composition which is a self-luminescent-material, is capable of generating light without using the back light unit. In other words, the main-panel 32 and the sub-panel 42 having the main organic light emitting layer 38 and the sub organic light emitting layer 48 are self-luminescent. In this embodiment, in order to transform provided energy from injected carriers into luminous energy, both the main organic light emitting layer 38 and the sub organic light emitting layer 48 comprise a hole injection layer (HIL), a hole transport layer (HTL), an emitting layer (EML), an electron injection layer (EIL), and an electron transport layer (ETL), where these layers are similar to the normal organic light emitting display without needing description in detail.

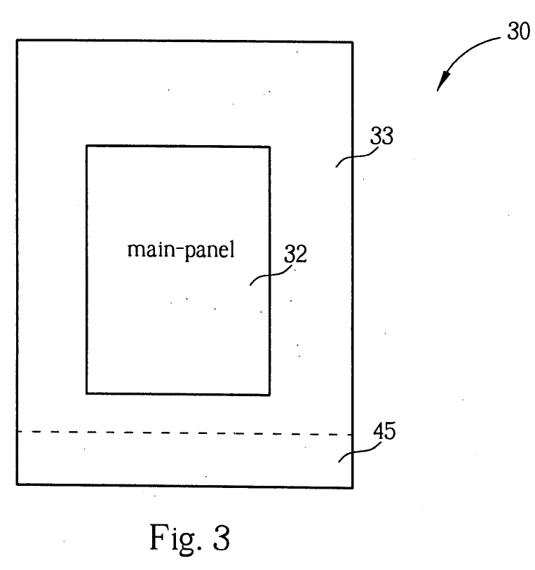

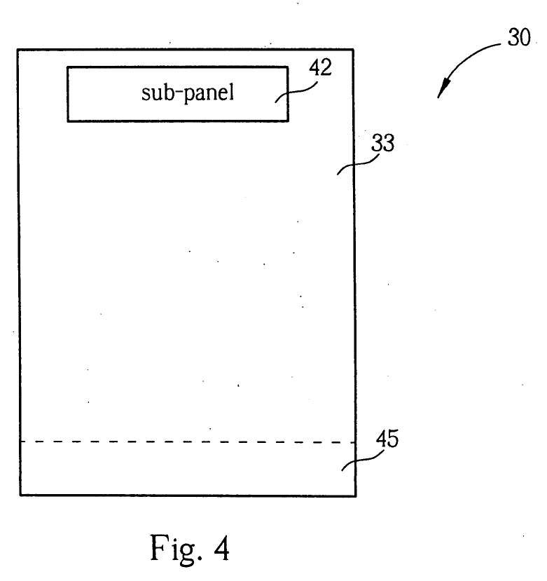

The main-panel 32 and the sub-panel 42 are electrically connected to the control module 45 used for controlling the main-panel 32 and the sub-panel 42 to generate light for two images with mutually reversed directions, i.e. the first display direction and the second display direction are opposite. The method of generating light for two images with opposite directions is applying a first bias voltage across the upper main substrate 34 and the bottom main substrate 36 of the main-panel 32, and applying a second bias voltage across the upper sub-substrate 44 and the bottom sub-substrate 46 of the sub-panel 42, so that the main organic light emitting layer 38 of the main-panel 32 generates the main image light progressing along the first displaying direction, and the sub organic light emitting layer 48 of the sub-panel 42 generates the sub image light progressing along the second displaying direction. This is because the carriers which are injected into the organic light emitting layer lead to different light directions for different direction currents. Since the first bias voltage is a reversed bias relative to the second bias voltage, hence, the progressing direction of the main-image light is against that of the sub-image light. Consequently, the present invention integrated double-sided organic light-emitting display 30 with a quite thin thickness, is capable of generating light in double sides. Therefore, the integrated double-sided organic light-emitting display 30 used in a mobile phone, a PDA or other portable devices can reduce a thickness of the whole device. Please refer to FIG. 3 and FIG. 4. FIG. 3 is a schematic diagram of the first embodiment on the side of the main-panel 32. FIG. 4 is a schematic diagram of the first embodiment on the side of the sub-panel 42. In addition, the integrated double-sided organic light-emitting display 30 is covered by a housing 33 shown in FIGS. 3 and 4.

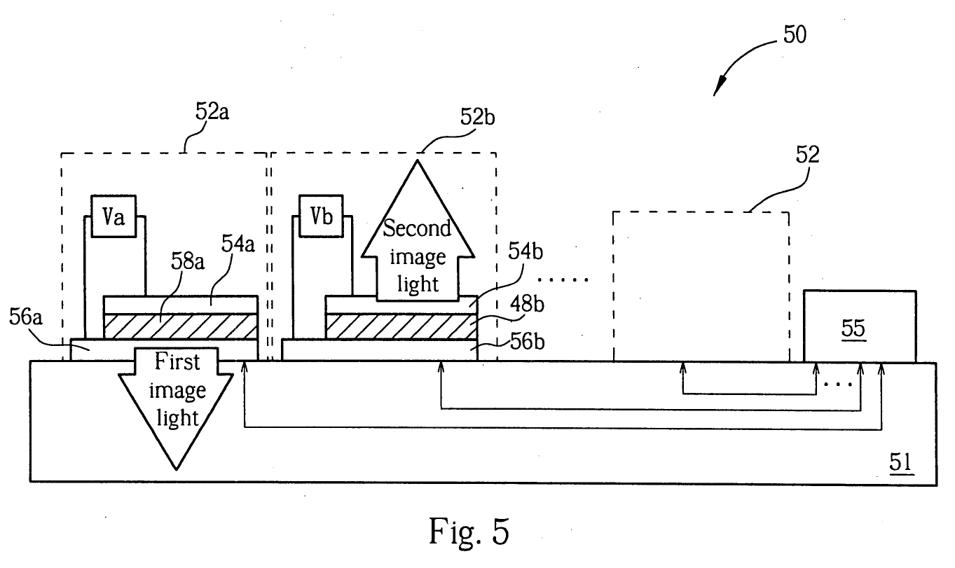

Please refer to FIG. 5, which shows a schematic diagram of a second embodiment of an integrated double-sided organic light-emitting display 50 according to the present invention. Differing from previous embodiment, the second embodiment is not limited to utilize two panels, but a plurality of displaying module 52 each capable of generating a corresponding image light in specific direction. The integrated double-sided organic light-emitting display 50 comprises a substrate 51 on which a control module 55 and the plurality of displaying module 52 are installed. Each displaying module 52 comprises a top electrode 54, a bottom electrode 56, and an organic light emitting 58 for generating a corresponding image light. The organic light emitting 58 is between the top electrode 54 and the bottom electrode 56. As depicted in the previous embodiment, each organic light emitting layer 58 comprises a hole injection layer (HIL), a hole transport layer (HTL), an emitting layer (EML), an electron injection layer (EIL), and an electron transport layer (ETL). Although the plurality of displaying modules 52 are controlled by the control module 55, the number of the control module is not limited to one.

Please refer to FIG. 5. Take the first displaying module 52a and the second displaying module 52b for example. For the first displaying module 52a, when a first bias voltage Va is applied on the first displaying module 52a, where the first bottom electrode 56a of the first displaying module 52a is served as an anode, a generated first image light is progressed along a first displaying direction, where the first displaying direction is from the first organic light emitting layer 58a toward the first bottom electrode 56a. For the second displaying module 52b, when a second bias voltage Vb is applied on the second displaying module 52b (the second bias voltage Vb is reverse biased relative to the first bias voltage Va), where the second bottom electrode 56b of the second displaying module 52b serves as a cathode, a generated second image light is progressed along a second displaying direction, where the second displaying direction is from the second organic light emitting layer 58b toward the second top electrode 54b. In this way, if the substrate 51 is not bent, i.e. the entire substrate 51 and the plurality of displaying modules 52 thereon are on a plane with the same normal line direction, the first displaying direction of the first image light generated by the first displaying module 52a is mutually reversed to the second displaying direction of the second image light generated by the second displaying module 52b in free space.

Similarly, the other displaying modules 52, besides the first displaying module 52a and the second displaying module 52b, have the same operation principle. Therefore, the integrated double-sided organic light-emitting display 50 shown in FIG. 5 can emit light toward double sides and has thin thickness, and can even have different light-emitting directions of individual displaying modules selected depending on the user's requirements. Furthermore, no matter if the displaying panel is bent, some specific areas on either sides of the present invention integrated double-sided organic light-emitting display can emit light, so that the user is capable of looking images on opposite sides of the integrated double-sided organic light-emitting display. In addition, the integrated double-sided organic light-emitting display is controlled by an integrated control module. Consequently, the organic light emitting diode (OLED) display panel, due to its advantages of high brightness, light weight, small volume, full color and few visual angle, is suitable for use in a mobile phone, a PDA or other portable devices.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An integrated double-sided organic light-emitting display panel comprising:
a substrate;
a main-panel installed on the substrate for generating a main image light substantially progressing along a first displaying direction;
a sub-panel installed on the substrate for generating a sub image light substantially progressing along a second displaying direction; and
a control module electrically connected with the main-panel and the sub-panel for controlling operations of the main-panel and the sub-panel;
wherein the first displaying direction is mutually reversed to the second displaying direction in free space.

2. The integrated double-sided organic light-emitting display panel of claim 1 being an Organic Light Emitting Diode (OLED) display panel or a PLED display panel.

3. The integrated double-sided organic light-emitting display panel of claim 1 wherein the main-panel comprises an upper substrate, a bottom substrate, and a main organic light emitting layer therebetween, and the sub-panel comprises an upper substrate, a bottom substrate, and a sub organic light emitting layer therebetween.

4. The integrated double-sided organic light-emitting display panel of claim 3 wherein the upper substrate and the bottom substrate are metal substrates.

5. The integrated double-sided organic light-emitting display panel of claim 3 wherein a first bias voltage is applied on the main-panel and a second bias voltage is applied on the sub-panel by using the control module, such that the main image light generated by the main organic light emitting layer is progressing along the first displaying direction and the sub image light generated by the sub organic light emitting layer is progressing along the second displaying direction.

6. The integrated double-sided organic light-emitting display panel of claim 5 wherein the first bias voltage is a reversed bias relative to the second bias voltage.

7. The integrated double-sided organic light-emitting display panel of claim 5 wherein the main organic light emitting layer and the sub organic light emitting layer each comprise a hole injection layer (HIL), a hole transport layer (HTL), an emitting layer (EML), an electron injection layer (EIL), and an electron transport layer (ETL).

8. The integrated double-sided organic light-emitting display panel of claim 1 wherein the substrate is a glass substrate or a plastic substrate.

9. The integrated double-sided organic light-emitting display panel of claim 1 being used in a mobile phone, a PDA, or other portable devices.

10. An integrated double-sided organic light-emitting display panel comprising:
a substrate;
a plurality of displaying modules installed on the substrate for generating a corresponding plurality of image light, each displaying module comprising:
a top electrode;
a bottom electrode; and
an organic light emitting layer installed between the top electrode and the bottom electrode for generating a corresponding image light; and
a control module for controlling operations of the plurality of displaying module.

11. The integrated double-sided organic light-emitting display panel of claim 10 wherein if the bottom electrode of each displaying module is served as an anode of the displaying module, the image light substantially progresses along a first displaying direction which is from the organic light emitting layer toward the bottom electrode; and if the bottom electrode of each displaying module is served as a cathode of the displaying module, the image light substantially progresses along a second displaying direction which is from the organic light emitting layer toward the top electrode.

12. The integrated double-sided organic light-emitting display panel of claim 11 wherein for each displaying module, the first displaying direction is mutually reversed to the second displaying direction in free space.

13. The integrated double-sided organic light-emitting display panel of claim 11 wherein for each displaying module, when a first bias voltage is applied on the displaying module, of which the bottom electrode is an anode, the image light substantially progresses along a first displaying direction which is from the organic light emitting layer toward the bottom electrode; and when a second bias voltage is applied on the displaying module, of which the bottom electrode is a cathode, the image light substantially progresses along a second displaying direction which is from the organic light emitting layer toward the top electrode.

14. The integrated double-sided organic light-emitting display panel of claim 13 wherein the first bias voltage is a reversed bias relative to the second bias voltage.

15. The integrated double-sided organic light-emitting display panel of claim 10 being an Organic Light Emitting Diode (OLED) display panel or a PLED display panel.

16. The integrated double-sided organic light-emitting display panel of claim 10 wherein the organic light emitting layer comprises a hole injection layer (HIL), a hole transport layer (HTL), an emitting layer (EML), an electron injection layer (EIL), and an electron transport layer (ETL).

17. The integrated double-sided organic light-emitting display panel of claim 10 being used in a mobile phone, a PDA, or other portable devices.
